(19) United States
(12) Patent Application Publication
(10) Pub. No.: US 2021/0264376 A1
(43) Pub. Date: Aug. 26, 2021

(54) MEETING LOCATION AND TIME SCHEDULER

(71) Applicant: Well Fargo Bank, N.A., San Francisco, CA (US)

(72) Inventors: Meltem Kilicoglu, New York, NY (US); Muhammad Farukh Munir, Pittsburg, CA (US); Brian M. Pearce, Pleasanton, CA (US); Wairnola Marria Rhodriquez, San Francisco, CA (US); Senthil K. Subramaniam, San Ramon, CA (US); Inna Treyger, San Francisco, CA (US)

(21) Appl. No.: 15/923,791

(22) Filed: Mar. 16, 2018

(51) Int. Cl. G06Q 10/10; G06F 17/27

(52) U.S. Cl. CPC G06Q 10/1095; G06F 17/2765

(57) ABSTRACT

Various examples described herein are directed to systems and methods for analyzing conversation data to determine a meeting is needed. A plurality of attendees for the meeting is determined. Calendar information for each of the plurality of attendees is retrieved. A common meeting date and time is determined based on the calendar information and the conversation data. A physical location for each of the plurality of attendees at the common meeting date and time is determined. A physical location within a building for the meeting is determined based on the physical location for each of the plurality of attendees. A building access list is updated with the plurality of attendees for the common meeting date and time.

### BACKGROUND

As companies employ people in various locations, finding common locations and times for meetings is difficult. In addition, employees are no longer working from a single location. Rather, employees may work from home or various different office locations. Accordingly, efficiently managing meeting locations and access to meeting locations also becomes more difficult. As the number of meetings increase, keeping track of meetings, agendas, and follow-up meetings may become unwieldy. Scheduling meetings at a common date and time of the attendees without requiring significant time would be useful.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not of limitation, in the figures of the accompanying drawings, in which:

FIG. 1 is a block diagram showing a system according to some embodiments.

FIG. 2 is a flow diagram showing a process for retrieving data based on sentimental analysis according to some embodiments.

FIG. 3 is a block diagram showing one example of a software architecture for a computing device.

FIG. 4 is a block diagram illustrating a computing device hardware architecture, within which a set or sequence of instructions can be executed to cause the hardware to perform examples of any one of the methodologies discussed herein.

### DETAILED DESCRIPTION

Scheduling meeting dates, times, locations, etc., is a complex task. In addition, moving meetings, scheduling follow-up meetings, and tracking meeting attendance and room usage makes meeting management more complex. Current systems are able to find common meeting times, but do not account for determining what attendees are likely to cancel or not show up or which attendees are not required to be present at the meeting when scheduling a date, time, and location for a meeting. Further, some previously scheduled meetings may be able to be moved to account for a meeting that is being scheduled. Various disclosed embodiments that are able to find a suitable meeting date, time, and location based on features determined from conversations and other data.

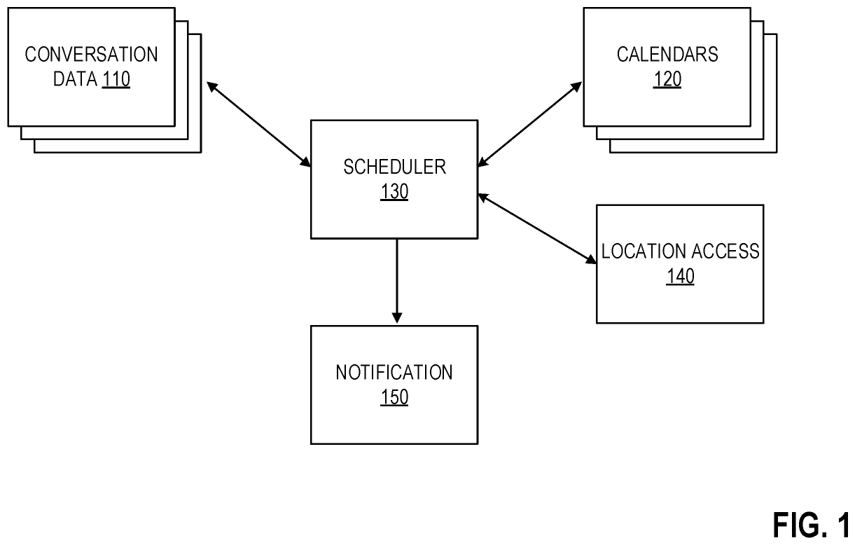

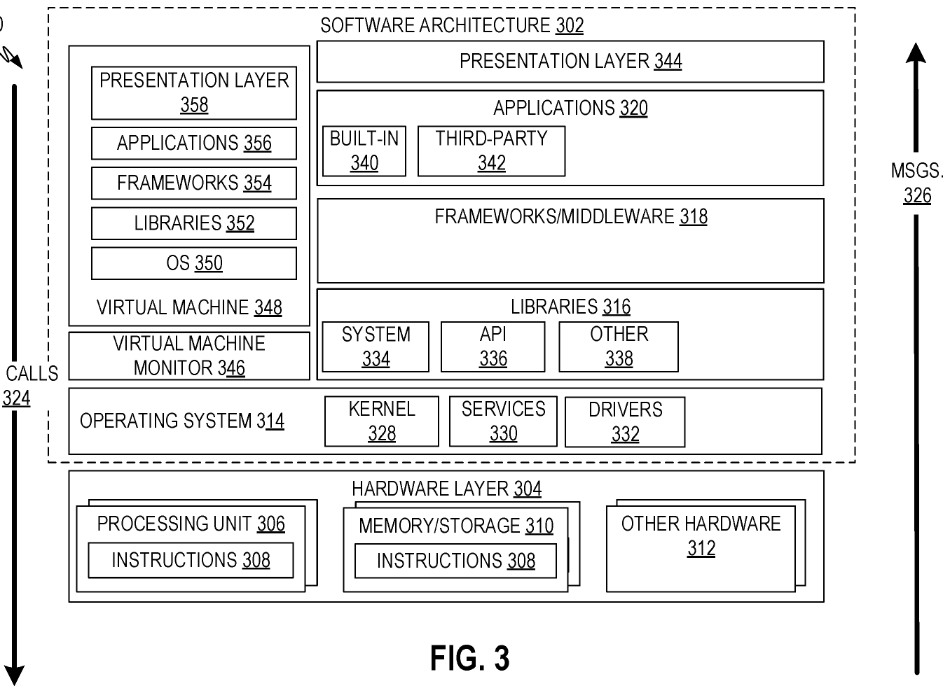

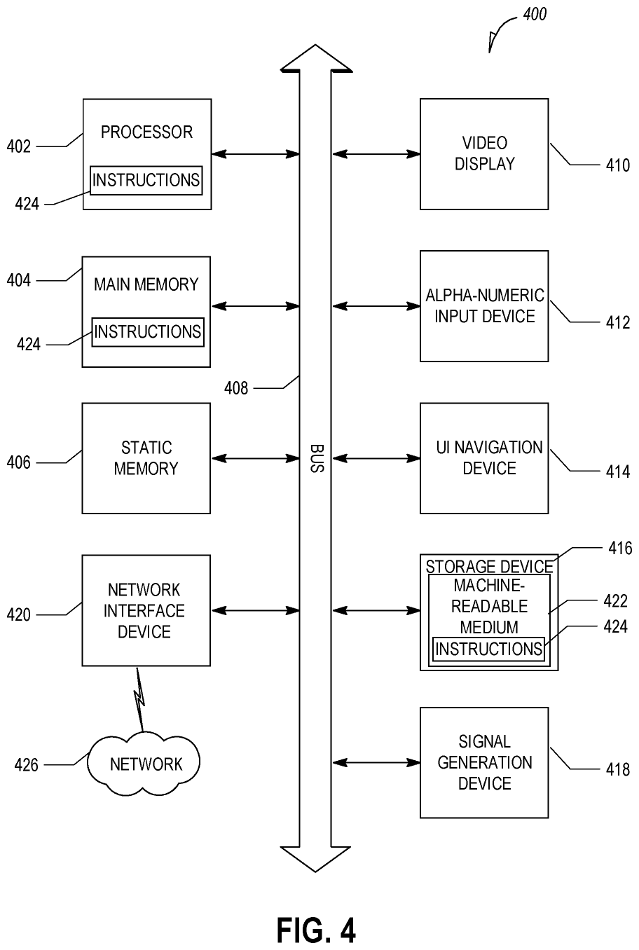

FIG. 1 is a block diagram showing a scheduling system according to some embodiments. A scheduler 130 receives conversation data 110 from various sources. For example, the conversation data 110 may include emails, chats, transcribed phone calls, etc. The scheduler 130 may be implemented on a scheduler computing device. The scheduler may be implemented on a software architecture described in FIG. 3 and executed on hardware described in FIGS. 3 and 4. Portions of the conversation data 110 may be associated with users based on the participants of a conversation. The scheduler 130 analyzes the conversation data 110 to determine if a meeting should be scheduled. For example, the scheduler 130 may search for keywords in the conversation data 110. In an example, the word “meeting” is first searched. If the word “meeting” is found, then words located within n-words of the word “meeting” are searched. The value n may be 3, 5, 10, etc. The second search may search for words such as “setup”, “need”, and “schedule”. Based on the conversation data 110, the scheduler 130 determines who is the organizer of the meeting. In an example, the organizer is the sender or receiver of the conversation data that included the keywords.

The scheduler 130 may also use the conversation data 110 to determine the attendees to the meeting. In an example, the names of the attendees may be provided directly within the conversation data 110. Names from a directory may be used to search for individual attendees. In addition, keywords such are “invite”, “attendees”, etc., may be used to locate the list of attendees. In another example, the scheduler 130 determines a topic of the meeting. This may be done based upon the location within the conversation data 110 that indicated a meeting was needed. Searching near this location may be done to identify a topic. For example, words within 3, 5, 8, etc., words of the location may be considered proximate to the location that is searched for a topic. In an example, a topic is determined from keywords. For example, the phrases “meeting for” or “meeting to” may be used to identify where a topic of the meeting is located. One or more words after the matching phrase may be used as the topic. In another example, a list of known projects and topics may be used as keywords to search for within the proximity of the location. Natural language processing and text analytics may be also be used to analyze the conversation data 110. Once the topic is determined, a list of users associated with the topic may be used as the list of attendees. For example, a keyword may match on a project name. The project name may be used to look up members of that project. Each member may then be an attendee to the meeting.

An initial date and/or time for the meeting may also be determined by the scheduler 130 using the conversation data 110. The location within the conversation data 110 that indicated the meeting was needed may be used to search for an initial date and/or time for the meeting. For example, three, five, fifteen, etc., words before and after the location may be searched for a date, time, and location. If a date, time, and/or location is found this will be used as the initial date, time, and/or location for scheduling the meeting. In an example, the phrase “for next week” may follow the phrase “schedule a meeting.” The “for next week” phrase may be used as an initial date range to find a meeting.

Once an initial list of attendees is determined, data from the attendees' calendars 120 may be retrieved by the scheduler 130. The calendars 120 are used to determine a date and time for a meeting that is available for all of the attendees. In an example, other events on a calendar may impact if an attendee is free. For example, an attendee may have a flight from 8 am until noon on the day of a meeting. While the time noon until 8 pm is free on that day, the scheduler 130 may determine that a window of time following noon is unavailable for the attendee based on the previous travel event. In an example, the window of time may be 1, 2, 4, etc., hours. In another example, the scheduler 130 may calculate a travel time between the destination airport and the meeting location for the attendee and use that to determine the unavailable window. For example, the scheduler 130 may determine the attendee is an hour away from the meeting location upon arrival. The scheduler 130 may add an additional amount of time, e.g., 2 hours, to the unavailable window to account for possible travel delays and setup time for the attendee.

The scheduler 130 searches for a free date and time for all of the attendees using an initial date, time, or date range. If there is no initial date, time, or date range, the scheduler 130 may start searching for a common free date and time starting a period of time in the future, e.g., two, six, eight, etc. hours. Time zones may be considered when searching for a common date and time. For example, the maximum difference in time zones from the attendees may be determined. If the attendees are all relatively close, e.g., all within four time zones, then the common time may be limited based upon business hours. If the attendees are spread further across the globe, e.g., more than four time zones, then the possible common times may be expanded to account for the time zones. For example, possible meeting times may be from 7 am until 9 pm for each attendee based on the attendee's time zone.

In addition to finding a common date and time for the meeting, the scheduler 130 may also determine locations for the meeting. In an example, all attendees are local and the scheduler 130 determines a room large enough to hold the attendees. In another example, one or more attendees may be remote. In this case, the scheduler 130 may include a telephone bridge in the meeting invite. The scheduler 130 may also determine if there are groups of attendees that are local to two or more different locations. For example, a project meeting between two remote groups may be scheduled, where each group is local to a different location. In this example, the scheduler 130 may determine a room for each of the two groups based on the size of each group. Once a physical location for the meeting is determined, the scheduler 130 may update a location access 140 system to indicate the attendees that will be at the location on the meeting date and time. For example, the scheduler 130 may provide a list of names, identifiers, date, time, meeting location, etc. to the location access 140 system. Attendees' access may then be streamlined on the date of the meeting when requesting access to the meeting's location.

Once the date, time, and location have been determined, the scheduler 130 may provide notification 150 to each of the attendees. In an example, the notification 150 may be a calendar invite. The calendar invite may include a portion of the conversation data 110 that was used to schedule the meeting. In addition, any telephone bridge information may also be included. In an example, an agenda may also be provided within the notification.

As an example of scheduling a meeting from conversation data, a portion of a conversation may include “We need to set aside an hour to meet next Thursday or Friday to discuss end of the year sales.” Analyzing the conversation data would result in a sixty-minute meeting needing to be scheduled sometime next Thursday or Friday. In addition, the topic of the meeting may be determined as end of the year sales. The attendees may then be determined as the sales team based on the meeting topic of end of the year sales. Once the attendees are determined, the calendars for those attendees may be retrieved. In an example, only calendar information for next Thursday and Friday would be retrieved initially. Based on this calendar data, the scheduler could search for a sixty-minute free block of time next Thursday and Friday. If a free block of time was found, this block of time could be the initial meeting time. If there are additional free blocks of time that meet the date range, these additional blocks of time could be included in the notification to allow for meeting modification.

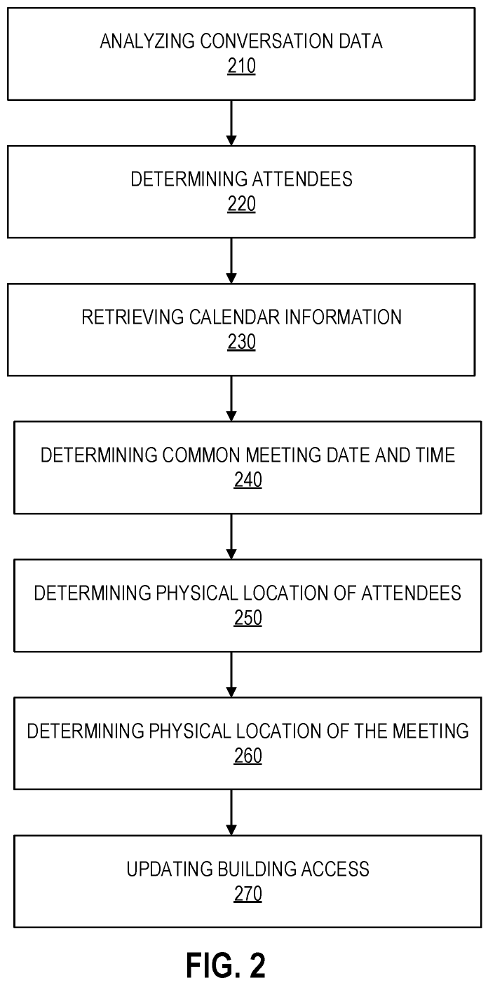

FIG. 2 is a flow diagram showing a process for retrieving data based on sentimental analysis according to some embodiments. The elements in FIG. 2 may be implemented on the software architecture described below in FIG. 3 and executed on computer hardware, such as the computer hardware in FIG. 4. At 210, conversation data from one or more users is received and analyzed. The scheduler 130 from FIG. 1 may be the computing device that does the receiving and analyzing. The conversation data is analyzed for indications that a meeting is to be scheduled. As described above, keywords may be used to determine if a meeting is needed. A matching location within the conversation data that indicates a meeting is needed may be stored for later use.

At 220, the attendees for the meeting are determined. The attendees may be determined from the conversation data. For example, searching in the proximity of the matching location may be done to identify the attendees. In an example, the attendees may be explicitly mentioned in the conversation data. A topic of the meeting may also be determined from the conversation data. The topic may then be used to determine a list of attendees associated with the topic. For example, using the example above the attendees may be determined to be the sale team based on the end of year sales meeting topic.

At 230, calendar information for each of the attendees is received. In an example, calendars for each of the attendees may be searched. For example, busy/not busy indications for the attendees may be retrieved. The date range, date, or time that a meeting may be scheduled may be determined from the conversation data as well. If a date range, date, or time was found, the date range, date, or time may be used to limit the calendar information that is requested and received.

At 240, the calendar information is used to determine a common period of time that is free for all of the attendees. In an example, the conversation data is used to determine a length of the meeting. In addition, a date range may also be determined from the conversation data. Based on the date range and length of meeting, the calendar information is searched for a free block of time that is at least the length of the meeting. In some examples, there may not be a date range determined from the conversation data. In these examples, some limited amount of time in the future may be used as the date range. For example, the next week, two weeks, month, etc., may be used as the date range.

If there are multiple common blocks of time found, additional information may be used to select an initial date and time. For example, each possible meeting time may have a ranking that is used to select the highest ranking meeting time as the initial meeting time. In an example, meetings that end at the end of a work day may be ranked lower than those earlier in the day. Similarly, early morning meetings may also be ranked lower than those later in the day. If a possible meeting time abuts with other meetings may also influence the meeting time's rank. For example, if multiple attendees have a long meeting before a potential meeting time, that meeting time may have its ranking reduced. Accordingly, meeting times that do not abut with meetings would be ranked higher.

Searching the calendar information may result in not finding a free time for the meeting that is suitable for every attendee. In an example, after determining there is no common free time, the scheduler may schedule the meeting over an existing meeting. The scheduler may use priorities of meetings to determine which meeting to schedule over. In an example, the scheduler looks for the lowest priority meeting and schedules the current meeting over the lowest priority meeting. In an example, the priority of a meeting may be determined based on the attendees, the recurring nature of the meeting, the number of conflicting attendees, and an explicit level of importance of the meeting. The priority of a meeting increases based on the number of conflicting attendees. In addition, a meeting that recurs may have its priority lowered. Past attendance by an attendee also may influence the priority. A meeting that is always attended by a conflicting attendee will increase the priority of the meeting, while a meeting where a conflicting attendee does not always attend will decrease the priority of the meeting. In addition, the role of a conflicting attendee may change the priority. A meeting whose organizer is a conflicting attendee will have its priority increased. Locality of conflicting attendees and meeting locations may also be used to change the priority of a meeting. A non-local conflicting attendee who will be in town for a conflicting meeting may have that meeting's priority increased. Such an increase helps to select a meeting date and time that allows the non-local conflicting attendee to still attend the conflicting meeting while local. The number of attendees to a meeting may influence the priority of a meeting. A small meeting may have an increase in priority compared to a larger meeting. In addition, if a conflicting meeting could be moved to a different free date and time that may lower the priority of the conflicting meeting.

Once the priorities of meetings are determined for a date range, a block of time sufficient for the scheduling meeting will be determined based on the lowest priority meeting. The date and time of the scheduled meeting will, therefore, conflict with the lowest priority meeting. The lowest priority meeting, however, is one that is determined to have a small impact on the number of attendees to both the scheduling meeting and to the lowest priority meeting. In an example, the scheduler may reschedule the lowest priority meeting to a new date and time. The lowest priority meeting may have different attendees; therefore, a common free date and time could be found for the lowest priority meeting. The scheduler may reschedule the lowest priority meeting in the same manner as scheduling a new meeting.

The scheduler may also update the list of attendees to a meeting when there is no common free date and time for a meeting. For example, a meeting to be scheduled may have an initial list of ten attendees. After searching the calendar information, the scheduler may determine there is no common free date and time available for the meeting. The scheduler may review historical meeting attendance for each of the attendees. If the meeting is a recurring meeting, the attendance of past recurring meetings may be used to determine if any attendees cancel or do not attend. In addition, attendance at other meetings may be used to determine a likelihood that each attendee will attend the meeting to be scheduled. This likelihood may be calculated based on the attendees of past meetings. For example, an attendee may rarely attend a meeting that is mostly attended by attendees from a different group or organization. If any attendee is determined likely to not attend the meeting to be scheduled, that attendee may be removed from the attendee list and the scheduler may search for a common date and time for the meeting using the reduced attendee list. If a common date and time is found, the meeting may be scheduled for that common date and time. Any removed attendee may still be invited to the meeting, but the meeting will conflict with something on that attendee's calendar.

Returning to FIG. 2, at 250 a physical location for each of the attendees is determined. This may be done based on the calendar information and the common date and time for the meeting. The physical locations may be a building that the attendee will be working. The scheduler may also determine a work location, such as a floor, cubicle, office, etc. where the attendee will be working on the common date and time for the meeting. If an attendee is working in the same building but on a different floor or a remote office compared to other attendees of the meeting, the scheduler may determine an alternate working location for the attendee that is closer to the other attendees. The scheduler may then send a message to the attendee with the alternate working location and recommend a change in the attendee's work location to the alternate working location.

At 260, a physical location within a building is determined for the meeting. The physical location for the meeting is based on the physical location of the attendees. In an example, if a number of attendees have a common location for the date and time of the meeting, a physical location, such as a conference room, meeting room, table, lab, etc., is scheduled for use of the meeting. If groups of attendees are spread over different locations, then multiple physical locations may be determined for the meeting. The physical location may be selected based on the number of attendees that will be at the location for the meeting. For example, a small conference room may be selected for a meeting where three attendees will attend locally.

At 270, the building access list for the building where the meeting is located is updated with the attendees that will be local for the meeting. The access list is updated such that the attendees will be granted access for the building on the date and time of the meeting. Updating the access list may include interfacing with the building access control system.

During the meeting, the meeting itself may be recorded using a recording device. The meeting may be recorded visually and/or audibly. Using the recording, the attendees that attended the meetings may be determined. In an example, the attendees state their name during an initial portion of the meeting. Audio analysis may also be done to determine the attendees. Any attendee not recognized as part of this analysis is determined to have not been present at the meeting. The visual and/or audio recording may be used for tonal analysis of the attendees. For example, stress levels may be analyzed during a meeting. Any meeting that has high stress levels may be flagged. Flagged meetings may be analyzed to determine potential problem areas. In addition, video and audio analysis may be used to determine if someone is not feeling well. This may be used to prompt an attendee to work from home or remind the attendee of unused sick or vacation days. The tonal analysis may also be used as feedback for individuals as part of a personalized review process.

In addition, the audio analysis may determine who took part in the meeting. In an example, the meeting is associated with a meeting agenda. The agenda may be attached to the meeting invite or provided to the scheduler. The agenda may include a list of items to be discussed at the meeting. In addition, attendees that will be in charge of an item may be included in the agenda. The audio analysis may include transcribing the meeting. The transcription may attribute discussion to individual attendees. This transcription may then be analyzed to determine which agenda items were discussed. In addition, which attendee took part in the discussion may also be determined. A summary for each agenda item based on the transcription may be then be created. For example, each agenda item may include who discussed the item, the transcription of the discussion, and any follow up items or meetings. In an example, the meeting transcription may be conversation data that is used to schedule follow up meetings.

The attendees that attended the meeting may be stored. In addition, the number of attendees that attended the meeting at a physical location may be stored. As the attendee information is stored over a number of meetings, how well physical locations used for meetings are utilized may be determined. For example, a building may have a number of locations that are used for meetings. After a period of time, e.g., three, six, twelve, etc. months, how the locations were utilized may be analyzed. This analysis may identify that locations are not being used. In addition, the analysis may identify areas where more meeting locations are needed. This analysis may be useful in real estate planning.

In addition to scheduling meetings, the scheduler may also provide attendees with a summary of upcoming meetings. The scheduler may determine that an attendee may be able to work from home based on the attendee's calendar information. Meeting information, such as the tonal analysis and/or transcription, may also be used as part of this determination. For example, an attendee may be identified as having coughed a number of times in a recent meeting. The scheduler may determine for the next work day the attendee has one scheduled meeting. The scheduler may determine the one scheduled meeting is one the attendee is not attending locally or may be moved to a later date. Based on this, the scheduler may send an alert to the attendee that the attendee has the option to work from home on the next work day.

FIG. 3 is a block diagram 300 showing one example of a software architecture 302 for a computing device. The architecture 302 may be used in conjunction with various hardware architectures, for example, as described herein. The software architecture 302 may be used to implement the scheduler 130 and the process in FIG. 2. FIG. 3 is merely a non-limiting example of a software architecture 302 and many other architectures may be implemented to facilitate the functionality described herein. A representative hardware layer 304 is illustrated and can represent, for example, any of the above referenced computing devices. In some examples, the hardware layer 304 may be implemented according to the architecture 302 of FIG. 3.

The representative hardware layer 304 comprises one or more processing units 306 having associated executable instructions 308. Executable instructions 308 represent the executable instructions of the software architecture 302, including implementation of the methods, modules, components, and so forth of FIGS. 1-2. Hardware layer 304 also includes memory and/or storage modules 310, which also have executable instructions 308. Hardware layer 304 may also comprise other hardware as indicated by other hardware 312 which represents any other hardware of the hardware layer 304, such as the other hardware illustrated as part of hardware architecture 400.

In the example architecture of FIG. 3, the software 302 may be conceptualized as a stack of layers where each layer provides particular functionality. For example, the software 302 may include layers such as an operating system 314, libraries 316, frameworks/middleware 318, applications 320 and presentation layer 344. Operationally, the applications 320 and/or other components within the layers may invoke application programming interface (API) calls 324 through the software stack and receive a response, returned values, and so forth illustrated as messages 326 in response to the API calls 324. The layers illustrated are representative in nature and not all software architectures have all layers. For example, some mobile or special purpose operating systems may not provide a frameworks/middleware layer 318, while others may provide such a layer. Other software architectures may include additional or different layers.

The operating system 314 may manage hardware resources and provide common services. The operating system 314 may include, for example, a kernel 328, services 330, and drivers 332. The kernel 328 may act as an abstraction layer between the hardware and the other software layers. For example, the kernel 328 may be responsible for memory management, processor management (e.g., scheduling), component management, networking, security settings, and so on. The services 330 may provide other common services for the other software layers. In some examples, the services 330 include an interrupt service. The interrupt service may detect the receipt of a hardware or software interrupt and, in response, cause the architecture 302 to pause its current processing and execute an interrupt service routine (ISR) when an interrupt is received. The ISR may generate the alert, for example, as described herein.

The drivers 332 may be responsible for controlling or interfacing with the underlying hardware. For instance, the drivers 332 may include display drivers, camera drivers, Bluetooth® drivers, flash memory drivers, serial communication drivers (e.g., Universal Serial Bus (USB) drivers), Wi-Fi® drivers, NFC drivers, audio drivers, power management drivers, and so forth depending on the hardware configuration.

The libraries 316 may provide a common infrastructure that may be utilized by the applications 320 and/or other components and/or layers. The libraries 316 typically provide functionality that allows other software modules to perform tasks in an easier fashion than to interface directly with the underlying operating system 314 functionality (e.g., kernel 328, services 330 and/or drivers 332). The libraries 316 may include system 334 libraries (e.g., C standard library) that may provide functions such as memory allocation functions, string manipulation functions, mathematic functions, and the like. In addition, the libraries 316 may include API libraries 336 such as media libraries (e.g., libraries to support presentation and manipulation of various media format such as MPEG4, H.264, MP3, AAC, AMR, JPG, PNG), graphics libraries (e.g., an OpenGL framework that may be used to render 2D and 9D in a graphic content on a display), database libraries (e.g., SQLite that may provide various relational database functions), web libraries (e.g., WebKit that may provide web browsing functionality), and the like. The libraries 316 may also include a wide variety of other libraries 338 to provide many other APIs to the applications 320 and other software components/modules.

The frameworks 318 (also sometimes referred to as middleware) may provide a higher-level common infrastructure that may be utilized by the applications 320 and/or other software components/modules. For example, the frameworks 318 may provide various graphic customer interface (GUI) functions, high-level resource management, high-level location services, and so forth. The frameworks 318 may provide a broad spectrum of other APIs that may be utilized by the applications 320 and/or other software components/modules, some of which may be specific to a particular operating system or platform.

The applications 320 includes built-in applications 340 and/or third-party applications 342. Examples of representative built-in applications 340 may include, but are not limited to, a contacts application, a browser application, a book reader application, a location application, a media application, a messaging application, and/or a game application. Third-party applications 342 may include any of the built in applications as well as a broad assortment of other applications. In a specific example, the third-party application 342 (e.g., an application developed using the Android™ or iOS™ software development kit (SDK) by an entity other than the vendor of the particular platform) may be mobile software running on a mobile operating system such as iOS™, Android™, Windows® Phone, or other mobile computing device operating systems. In this example, the third-party application 342 may invoke the API calls 324 provided by the mobile operating system such as operating system 314 to facilitate functionality described herein.

The applications 320 may utilize built in operating system functions (e.g., kernel 328, services 330 and/or drivers 332), libraries (e.g., system 334, APIs 336, and other libraries 338), frameworks/middleware 318 to create user interfaces to interact with users of the system. Alternatively, or additionally, in some systems interactions with a user may occur through a presentation layer, such as presentation layer 344. In these systems, the application/module “logic” can be separated from the aspects of the application/module that interact with a user.

Some software architectures utilize virtual machines. For example, systems described herein may be executed utilizing one or more virtual machines executed at one or more server computing machines. In the example of FIG. 3, this is illustrated by virtual machine 348. A virtual machine creates a software environment where applications/modules can execute as if they were executing on a hardware computing device. A virtual machine is hosted by a host operating system (operating system 314) and typically, although not always, has a virtual machine monitor 346, which manages the operation of the virtual machine as well as the interface with the host operating system (i.e., operating system 314). A software architecture executes within the virtual machine such as an operating system 350, libraries 352, frameworks/middleware 354, applications 356 and/or presentation layer 358. These layers of software architecture executing within the virtual machine 348 can be the same as corresponding layers previously described or may be different.

FIG. 4 is a block diagram illustrating a computing device hardware architecture 400, within which a set or sequence of instructions can be executed to cause the machine to perform examples of any one of the methodologies discussed herein. For example, the architecture 400 may execute the software architecture 302 described with respect to FIG. 3. The architecture 400 may operate as a standalone device or may be connected (e.g., networked) to other machines. In a networked deployment, the architecture 400 may operate in the capacity of either a server or a client machine in server-client network environments, or it may act as a peer machine in peer-to-peer (or distributed) network environments. The architecture 400 can be implemented in a personal computer (PC), a tablet PC, a hybrid tablet, a set-top box (STB), a personal digital assistant (PDA), a mobile telephone, a web appliance, a network router, switch or bridge, or any machine capable of executing instructions (sequential or otherwise) that specify operations to be taken by that machine.

Example architecture 400 includes a processor unit 402 comprising at least one processor (e.g., a central processing unit (CPU), a graphics processing unit (GPU) or both, processor cores, compute nodes, etc.). The architecture 400 may further comprise a main memory 404 and a static memory 406, which communicate with each other via a link 408 (e.g., bus). The architecture 400 can further include a video display unit 410, an alphanumeric input device 412 (e.g., a keyboard), and a user interface (UI) navigation device 414 (e.g., a mouse). In some examples, the video display unit 410, input device 412 and UI navigation device 414 are incorporated into a touch screen display. The architecture 400 may additionally include a storage device 416 (e.g., a drive unit), a signal generation device 418 (e.g., a speaker), a network interface device 420, and one or more sensors (not shown), such as a global positioning system (GPS) sensor, compass, accelerometer, or other sensor.

In some examples, the processor unit 402 or other suitable hardware component may support a hardware interrupt. In response to a hardware interrupt, the processor unit 402 may pause its processing and execute an interrupt service routine (ISR), for example, as described herein.

The storage device 416 includes a machine-readable medium 422 on which is stored one or more sets of data structures and instructions 424 (e.g., software) embodying or utilized by any one or more of the methodologies or functions described herein. The instructions 424 can also reside, completely or at least partially, within the main memory 404, static memory 406, and/or within the processor 402 during execution thereof by the architecture 400, with the main memory 404, static memory 406, and the processor 402 also constituting machine-readable media. Instructions stored at the machine-readable medium 422 may include, for example, instructions for implementing the software architecture 402, instructions for executing any of the features described herein, etc.

While the machine-readable medium 422 is illustrated in an example to be a single medium, the term “machine-readable medium” can include a single medium or multiple media (e.g., a centralized or distributed database, and/or associated caches and servers) that store the one or more instructions 424. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including, but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 424 can further be transmitted or received over a communications network 426 using a transmission medium via the network interface device 420 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, and 6G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

Various components are described in the present disclosure as being configured in a particular way. A component may be configured in any suitable manner. For example, a component that is or that includes a computing device may be configured with suitable software instructions that program the computing device. A component may also be configured by virtue of its hardware arrangement or in any other suitable manner.

The above description is intended to be illustrative, and not restrictive. For example, the above-described examples (or one or more aspects thereof) can be used in combination with others. Other embodiments can be used, such as by one of ordinary skill in the art upon reviewing the above description. The Abstract is to allow the reader to quickly ascertain the nature of the technical disclosure, for example, to comply with 37 C.F.R. § 1.72(b) in the United States of America. It is submitted with the understanding that it will not be used to interpret or limit the scope or meaning of the claims.

Also, in the above Detailed Description, various features can be grouped together to streamline the disclosure. However, the claims cannot set forth every feature disclosed herein as embodiments can feature a subset of said features. Further, embodiments can include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1. A method of operating a scheduler comprising operations performed using an electronic processor, the operations comprising:
analyzing conversation data to determine a meeting is needed, wherein the scheduler uses one of natural language processing or text analytics to search for a first keyword in the conversation data and then a second keyword in the conversation data that is located n-words from the first keyword;
determining a plurality of attendees for the meeting;
retrieving calendar information for each of the plurality of attendees;
receiving an audio recording of a previous meeting attended by one attendee of the plurality of attendees, wherein the audio recording includes an audio recording of the one attendee where a tonal analysis is performed on the audio recording using one of natural language processing or text analytics on the one attendee;
determining a meeting date and time based on the calendar information and the conversation data, wherein determining a meeting date and time comprises:
determining there is no common meeting date and time available based on the calendar information; and
determining a priority of the meeting based on determining there is no common meeting date and time available and previous attendance of an attendee at a previous meeting;
determining a physical location for each of the plurality of attendees at the meeting date and time, wherein the tonal analysis is performed on the audio recording to determine if the one attendee should be at the physical location;
prompting the one attendee to work at an alternate location based on the tonal analysis during the meeting date and time;
determining a physical location within a building for the meeting based on the physical location for each of the plurality of attendees; and
updating a building access list of the building with the attendee from the plurality of attendees for the meeting date and time; wherein the scheduler interfaces with a building access control system to allow the attendee access to the building for the meeting.

2. The method of claim 1, wherein the conversation data comprises email and voice recognition of phone calls.

3. The method of claim 1, wherein the analyzing conversation data comprises searching email for keywords related to a meeting, wherein the keywords comprise need, schedule, and meeting.

4. The method of claim 1, wherein the determining a plurality of attendees for the meeting comprises:
determining a location within the conversation data associated with determining the meeting is needed; and
searching within proximity of the location to determine a topic of the meeting; where the plurality of attendees is based on the topic of the meeting.

5. The method of claim 1, wherein the determining a meeting date and time comprises:
finding a lower priority meeting on the date of the meeting, wherein one of the plurality of attendees is scheduled to attend the lower priority meeting; and
determining a date and time of the lower priority meeting is available for the plurality of attendees other than the one of the plurality of attendees scheduled to attend the lower priority meeting, wherein the meeting date and time is the date and time of the lower priority meeting.

6. The method of claim 5, further comprising:
determining a new meeting date and time for the lower priority meeting; and
moving the lower priority meeting to the new meeting date and time.

7. The method of claim 1, wherein the determining a meeting date and time comprises:
determining there is no common meeting date and time available based on the calendar information;
determining an attendee that has not attended past meetings based on the calendar information;
updating the plurality of attendees by removing the attendee from the plurality of attendees; and
determining the meeting date and time for the updated plurality of attendees.

8. The method of claim 1, wherein the determining a physical location comprises determining a number of the plurality of attendees that are local to the physical location, where the physical location is based on the number.

9. The method of claim 1, further comprising:
storing a number of attendees that attended the meeting at the date and time; and
storing a number of local attendees that attended the meeting at the date and time.

10. The method of claim 1, further comprising determining a building that has unused meeting rooms over a period of time.

11. The method of claim 1, further comprising recording the meeting.

12. The method of claim 11, further comprising determining people who attended and people who did not attend the meeting based on the recording.

13. The method of claim 11, further comprising:
receiving an agenda item for the meeting;
determining which attendees discussed the agenda item based on the recording; and
creating a summary of the agenda item based on the recording.

14. The method of claim 1, further comprising:
determining a work location of a first attendee on the meeting date;
determining work locations of other attendees on the meeting date; and
sending a message to the first attendee recommending a change in the work location of the first attendee based on the work locations of the other attendees.

15. A system comprising:
a scheduler computing device comprising an electronic processor, the electronic processor configured to:
analyze conversation data to determine a meeting is needed, wherein the scheduler computer device uses one of natural language processing or text analytics to search for a first keyword in the conversation data and then a second keyword in the conversation data that is located n-words from the first keyword;
determine a plurality of attendees for the meeting;
retrieve calendar information for each of the plurality of attendees;
receive an audio recording of a previous meeting attended by one attendee of the plurality of attendees, wherein the audio recording includes an audio recording of the one attendee where a tonal analysis is performed on the audio recording using one of natural language processing or text analytics on the one attendee;
determine a meeting date and time based on the calendar information and the conversation data, wherein when determining a meeting date and time, the scheduler computer device is further configured to:
determine there is no common meeting date and time available based on the calendar information; and
determine a priority of the meeting based on determining there is no common meeting date and time available and previous attendance of an attendee at a previous meeting;
determine a physical location for each of the plurality of attendees at the meeting date and time, wherein the tonal analysis is performed on the audio recording to determine if the one attendee should be at the physical location;
prompt the one attendee to work at an alternate location based on the tonal analysis during the meeting date and time;
determine a physical location within a building for the meeting based on the physical location for each of the plurality of attendees; and
update a building access list of the building with an attendee from the plurality of attendees for the meeting date and time, wherein the scheduler computing device interfaces with a building access control system to allow the attendee access to the building for the meeting.

16. The system of claim 15, wherein the conversation data comprises email and voice recognition of phone calls.

17. The system of claim 16, wherein to analyze conversation data the electronic processor is configured to search email for keywords related to a meeting, wherein the keywords comprise need, schedule, and meeting.

18. The system of claim 17, wherein to determine a plurality of attendees for the meeting the electronic processor is configured to:
determine a location within the conversation data associated with determining the meeting is needed; and
search within proximity of the location to determine a topic of the meeting, where the plurality of attendees is based on the topic of the meeting.

19. A non-transitory machine-readable medium, of a scheduler, comprising instructions thereon that, when executed by at least one processor unit of the scheduler, causes the at least one processor unit to perform operations comprising:
analyzing conversation data to determine a meeting is needed, wherein the scheduler uses one of natural language processing or text analytics to search for a first keyword in conversation data and then a second keyword in the conversation data that is located n-words from the first keyword;
determining a plurality of attendees for the meeting;
retrieving calendar information for each of the plurality of attendees;
receiving an audio recording of a previous meeting attended by one attendee of the plurality of attendees, wherein the audio recording includes an audio recording of the one attendee where a tonal analysis is performed on the audio recording using one of natural language processing or text analytics on the one attendee;
determining a meeting date and time based on the calendar information and the conversation data; wherein determining a meeting date and time comprises:
determining there is no common meeting date and time available based on the calendar information; and
determining a priority of the meeting based on determining there is no common meeting date and time available and previous attendance of an attendee at a previous meeting;
determining a physical location for each of the plurality of attendees at the meeting date and time, wherein the tonal analysis is performed on the audio recording to determine if the one attendee should be at the physical location;
prompting the one attendee to work at an alternate location based on the tonal analysis during the meeting date and time;
determining a physical location within a building for the meeting based on the physical location for each of the plurality of attendees; and
updating a building access list of the building with the attendee from the plurality of attendees for the meeting date and time; wherein the scheduler interfaces with a building access control system to allow the attendee access to the building for the meeting.

20. The non-transitory machine-readable medium of claim 19, wherein the operations determining a plurality of attendees for the meeting comprises:
determining a location within the conversation data associated with determining the meeting is needed; and
searching within proximity of the location to determine a topic of the meeting, where the plurality of attendees is based on the topic of the meeting.
